(19) United States
(12) Patent Application Publication
(10) Pub. No.: US 2001/0045347 A1
(43) Pub. Date: Nov. 29, 2001

(54) Electrical connecting device for contacting conductor wires

(76) Inventors: Ladstatter Gerald, Dornbirn (AT); Gadner Wolfgang, Horbranz (AT)

Correspondence Address: FITZPATRICK CELLA HARPER & SCINTO, 30 ROCKEFELLER PLAZA, NEW YORK, NY, 10112, US

(21) Appl. No.: 09/893,641

(22) Filed: Jun. 29, 2001

Related U.S. Application Data
(63) Continuation of application No. PCT/EP99/10398, filed on Dec. 27, 1999.

(30) Foreign Application Priority Data
Dec. 30, 1998 (DE) 298 23 255.3
Dec. 30, 1998 (DE) 298 23 256.1

(51) Int. Cl. H01R 24/00

(52) U.S. Cl. 200/51.05

(57) ABSTRACT

The invention relates to an electrical connection device for contacting conductor wires of a plurality of electrical conductors (12), running in a strip-like manner, of a conductor wire combination, with the conductor wires of electrical connection lines of an electrical consuming unit, in particular a light of a lighting strip system, whereby the connection device (13) has a coupling part (13a) and a counter-coupling element (13b) having contact elements (16) which upon plugging together of the counter-coupling element (13b) with the coupling parts (13a) each make a current connection to associated conductor wires, whereby the contact elements (16) are arranged in two rows (R1, R2) extending transversely to the conductor wires and there is associated with one row (R1) a contact position selection device (25a) for displacing at least one contact element (16) between at least two neighboring contact positions. For the purpose of improving the adaptability of the connection device to different functions and/or current supplies and/or installation situations, there is also displaceably arranged in the second row (R2) a contact position selection device (25b) for moving at least one of the contact elements (16) arranged in this second row (R2) between two contact positions neighboring one another.

The invention relates to an electrical connecting device in accordance with the preamble of claim 1.

An electrical connecting device of this kind is described in 196 15 597 A1. With this known connecting device there is provided a conductor wire combination in the form of a through-wiring having five conductor wires, in particular as a flat ribbon, which is located in a carrier rail of a lighting strip system. Thereby, in each case one light is electrically connectable with the conductor wire combination by means of two connecting devices. The contacts of the connecting devices are located in each case in two rows extending transversely to the longitudinal direction of the conductor wires, whereby in the one row there are located three phase contacts and in the other row an earthing contact and a neutral line contact. In the contact row in which the phase contacts are located there is arranged on the associated counter-coupling element a phase selection device which makes it possible selectively to contact one of the three available phases. By this means it is possible to distribute the plurality of lights of the lighting strip system over three phases. It is thus possible so to set lights having per se like counter-coupling elements that different phases are contacted and thus an overloading of a phase is avoided.

With modern electrical current supply devices, such as e.g. a lighting strip system, there is requirement for a particular adaptability, e.g. for the purpose of adaptation to at least one current supply network and/or control current supply network.

The object of the invention is to improve an electrical connecting device of the kind indicated in the introduction with regard to its adaptability to various functions and/or current supplies and/or installation situations.

This object is achieved by means of the features of claim 1. Advantageous developments of the invention are indicated in the subclaims.

The connection device in accordance with the invention has in both contact rows a contact selection device. Thereby, the selection devices can in each case relate to a plurality of or all of the contacts arranged in the associated row. That is, in each contact row the connecting device can be so set that selection can be made between two or between more or between all contacts. By these means the goal is achieved of improving the adaptability of the connecting device.

Thereby it is advantageous in particular for safety reasons and for the purpose of simplification to arrange an associated earthing contact non-adjustably. By these means the likelihood is reduced that earthing is interrupted through an adjustment of the earthing contact.

It is for example possible within the scope of the invention to contact different current networks with the connecting device, e.g. a current supply network and/or an emergency current supply network and/or a control current network. Thereby it is further advantageous when a plurality of current networks are provided, e.g. two emergency current supply networks, which can be contacted with the one or the other selection device. By these means it is possible to distribute associated lights over the plurality of current networks, e.g. two emergency current supply networks, so that an overloading of one current network is avoided.

Features are contained in further subclaims which lead to compact and simple constructions which can be advantageously integrated into a connection device, and which beyond this ensure an economical configuration and a good functioning, which inter alia make possible also simple adjustment and setting of the connection device.

Below, the invention and further advantages which can be achieved thereby will be described in more detail with reference to simplified drawings and advantageous embodiments. There is shown:

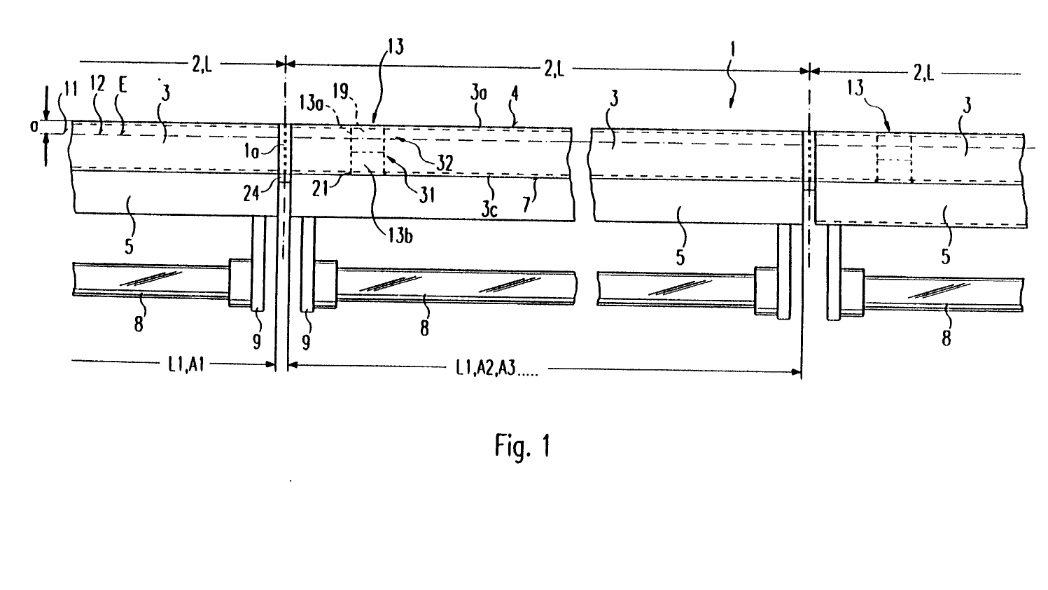

FIG. 1 a plurality of lighting strip sections, in accordance to the invention, of a lighting strip system, in each case with a carrier rail and a plurality of lights applied thereto, in a side view;

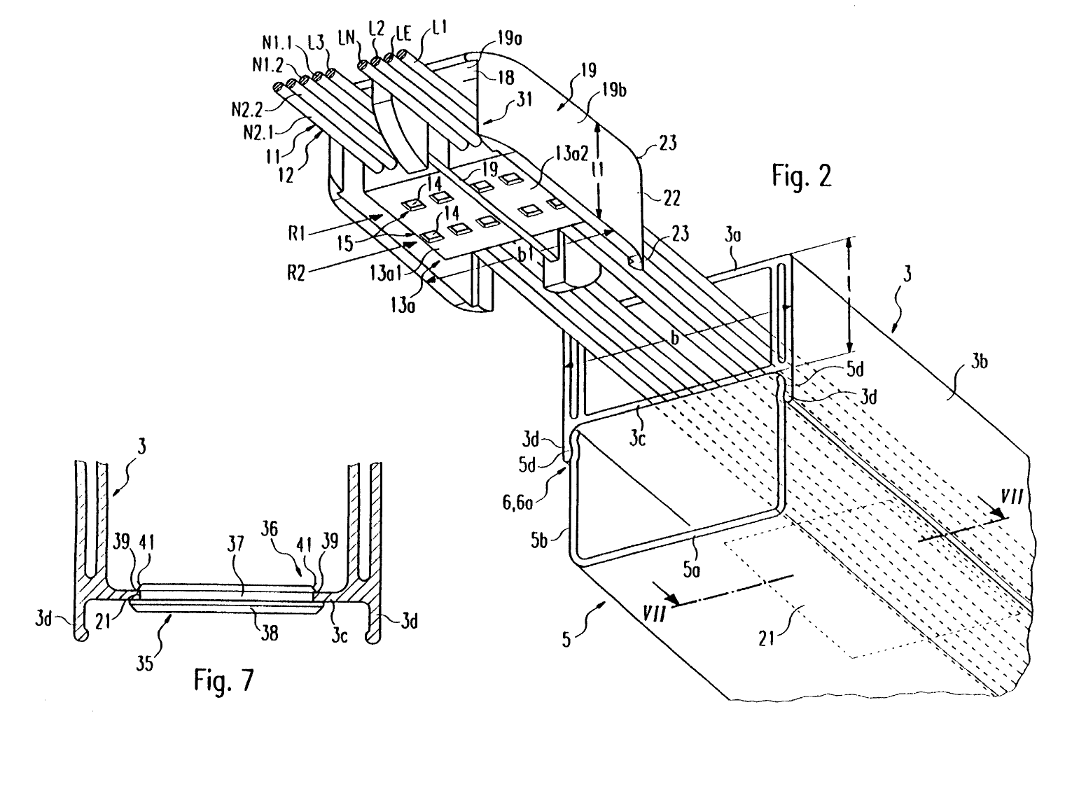

FIG. 2 a lighting strip section according to a first exemplary embodiment, in a perspective section;

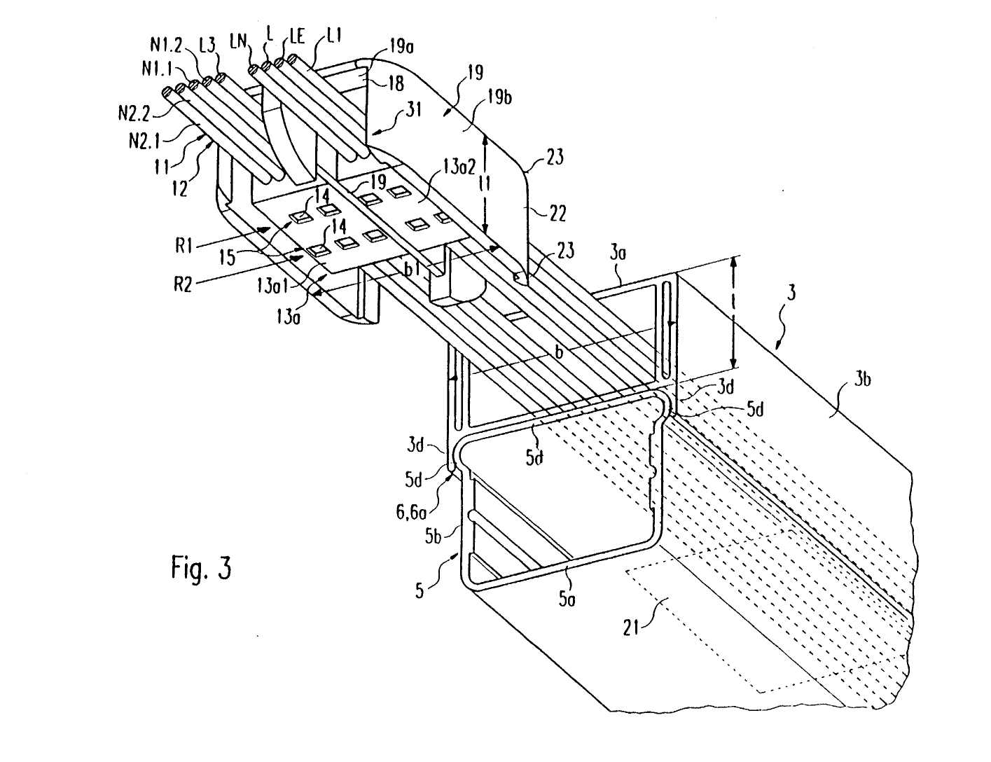

FIG. 3 a lighting strip section in accordance with a second exemplary embodiment, in a perspective section;

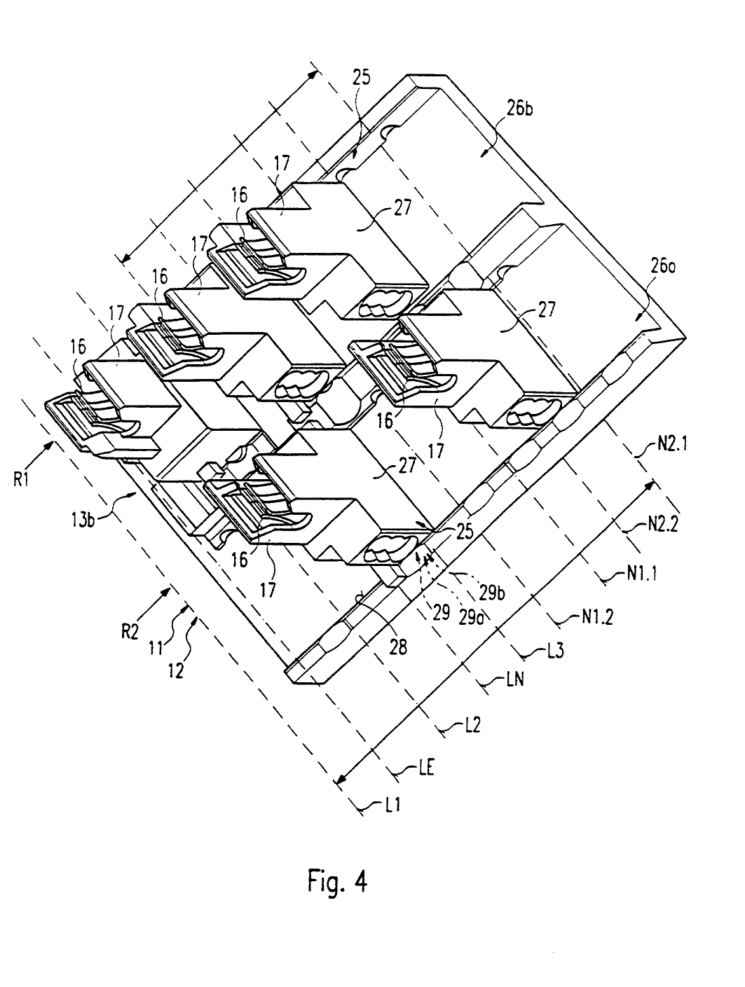

FIG. 4 a plug-in connection part in a perspective view from above;

FIG. 5 a plug-in connection part of the carrier rail in schematic illustration of its contact elements;

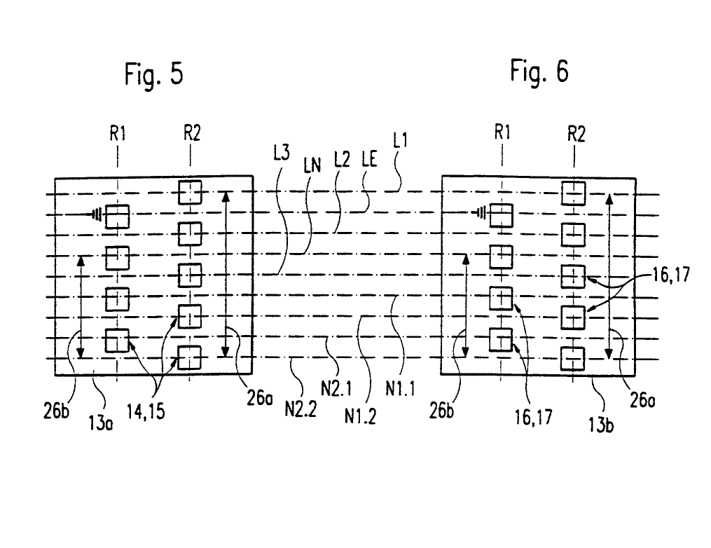

FIG. 6 a plug-in connection part of a light in schematic illustration of its contact elements;

FIG. 7 the partial section VII-VII of FIG. 2.

Of the lighting strip designated by 1 in FIG. 1 there is illustrated only a longitudinal section of the associated lighting strip system, which consists of a plurality of lighting strip sections 2 or modules arranged in a row one after another, the lengths L of which sections or modules are preferably the same but which in principal may differ, for example being determined by a transportable length of e.g. about 4 m to 6 m. The schematically illustrated joints of the lighting strip sections 2 are designated by 1a. Since the lighting strip sections 2 are identically formed, in the following only one lighting strip section 2 will be described.

The main parts of the lighting strip section 2 are a carrier rail 3, tube-like or U-shaped in cross-section, having a base side 4, shown in FIG. 1 to the top, with which the carrier rail 3 can be attached to a carrier (not shown), e.g. a room ceiling or a room wall, by means of non-illustrated first fastening means, e.g. screws, a plurality of similar lights A1, A2, A3 . . . , arranged one after another in the longitudinal direction of the lighting strip 1, in each case with a tub-shaped light body 5, which are each releasably connectable with the connection side 7 of the carrier rail 3, away from the base side 4, by means of non-illustrated second fastening means, e.g. a quick-fastening connection 6 or a latching device 6a, one or more lamps 8 arranged in parallel in, or with the present exemplary embodiment, on the light body 5, in this case gas discharge tubes, which are held by means of mountings on mounting bodies 9 on the light body 5 and by means of length of which the length L1 of the light bodies 5 is determined, a through-wiring 11 having a plurality of wires 12, preferably nine wires 12, extending longitudinally through the carrier rail 3, which wires are arranged in a plane E extending parallel to the base wall 3a of the carrier rail at a spacing a from the base wall 3a and which may be formed by one or two so-called flat conductor ribbons the individual wires of which ribbon or ribbons are held together by means of a ribbon extending longitudinally of the plane, a plurality of plug-in connections 13, each for a light A1, A2, A3 . . . , preferably arranged—seen transversely of the longitudinal direction—off-centre, and having a first plug-in connection part 13a preferably in the form of a socket which is arranged in the carrier rail 3, and at the end face towards the light body 5 having plug openings 14 of the same number as the wires 12 present, in which in each case a schematically illustrated contact element 15 can be arranged, which is located in a chamber, and a second plug-in connection part 13b corresponding thereto, preferably in the form of a plug, which is arranged on the light body 5 in apposition to the plug-in connection part 13a and has counter plug-in contact elements 16 each in apposition to the plug openings 14 arranged in one or two transverse rows R1, R2, which in each case can be contacted with a respective associated contact element 15 in the plug-in connection part 13a.

With the present configuration, the plug contact elements 16 are each located in a plug shaft 17 the cross-sectional shape and size of which is so adapted to the cross-sectional shape and size of the plug openings 14 that it can be plugged therein with slight play for movement and thus attains a guiding directed transversely to the longitudinal direction of the lighting strip 1.

The carrier rail 3 is a profile section which can be manufactured by extrusion or, in the case of a U-shaped cross-section, can be manufactured by bending.

The number of light bodies 5 arranged one after another in the length region L of the lighting strip section 2 is determined by the length L1 of the lighting bodies 5, which is determined by means of conventional standardised dimensions of the elongate lamps 8, in particular gas discharge tubes. The mounting bodies 9 are arranged at the ends of the light bodies 5 whereby in each case they stand out from the light body 5 on the connection side away from the carrier rail 3. The lamps 8 may each be covered by means of a protective sleeve, which is not shown for reasons of simplification.

With the exemplary embodiment according to FIGS. 2 and 3 the first plug-in connection parts 13a are in each case formed by means of two plug-in connection parts 13a1, 13a2 in the shape of plug-in sleeves, arranged transversely next to one another, which form plug coupling parts and in each case are arranged and positioned in a chamber 18 of a slide 19, e.g. by means of non-illustrated latching devices. With the present configuration, the slide 19 has, in cross-section, a U-shape having a slide floor wall 19a towards the base side 4 and slide side walls 19b, extending in longitudinal direction, between which the one or both plug-in connection parts 13a, 13a1, 13a2 are arranged transversely adjacent one another and which may be separated from one another by means of middle wall 19c of the slide 19 running longitudinally. In a comparable manner the second plug-in connection part 13b associated with the respective light A1, A2, A3, can be formed by means of two plug-in connection parts 13b1, 13b2 or plugs, lying transversely adjacent one another.

The plug-in sleeves 13a1, 13a2 and the associated plug-in connection parts 13a, 13b1, 13b2 having plug-in contact elements in each case form plug-in couplings and plug-in counter-couplings for the direct or indirect electrical connection of the plug-in contact elements 16 with the associated wires 12. Within the scope of the invention, the plug-in contact elements may co-operate with contact elements 15 allocated to the associated plug-in connection part 13a, or the plug-in contact elements 16 may stand in direct contact with the associated wires 12, whereby there may be involved the usual clamping contact elements or cutting/clamping contact elements, whereby the latter can cut into and contact insulated electrical wires 12. The mountings are in each case connected by means of conventional electrical conductors with the associated plug-in connection parts 13b, 13b1, 13b2.

The carrier rail 3 may have a U-shape in cross-section, whereby its side walls 3b form the limbs of the U-shape and its cover wall 3c forms the web wall of the U-shape, or it may have the shape of a preferably quadrilateral tube which is formed by means of the base wall 3a, the cover wall 3c and the side walls 3b. With the present configuration, the width b of the carrier rail 3 is greater than its depth t directed transversely to the plane E, whereby the sidewalls 3b form narrow sides and the cover wall 3c forms a broad side. In the cover wall 3c there is present, opposite to each first plug-in connection part 13a, a common plug recess 21 for the second plug-in connection part 13b or there is present a plurality of plug recesses (not shown) for the plug shafts 17. In both cases the second plug-in connection part 13b is contactable with the first plug-in connection part 3a, through the cover wall 3c and into the hollow space of the carrier rail 3.

The plug recess 21 or a plurality of above-described smaller plug recesses in the hole pattern of the plug shafts 17 can be worked e.g. by stamping the cover wall 3c at the particular locations concerned, at which a plug-in connection part 13b is in each case arranged. The respective arrangement position is indicated by means of the position of the plug-in connection part 13b on the light body 5.

The width b1 and the depth t1 of the slide 19 are so adapted to the associated internal dimensions of the carrier rail 3 that the slide 19 is longitudinally displaceable in the carrier rail 3 with slight play for movement, whereby the base rail 3 forms a guide for the slide 19. In order to facilitate jamming and the introduction of the slide 19 into the carrier rail 13 the end face edges of the slide 19 are interrupted by means of edge breaks 22, 23 or oblique surfaces or roundings.

The light body 5 may be box-like and U-shaped in cross-section, as is shown in FIG. 2, or tube-like as is shown in FIG. 3. In both cases the light body 5 has a base wall 5a and side walls 5b extending therefrom, which in the case of a tube-shape are connected with one another by means of a cover wall 5c, whereas in the case of a U-shape they are free web walls. As FIG. 3 further shows, with this exemplary embodiment the recesses 21 for the walls 3c and 5c are in each case common.

The quick-fastening connection 6 is preferably a latching device 6a the latching effect of which can be manually overcome so that the light body 5 can be pressed into the latching device 6a upon its mounting, with a certain mounting or dis-mounting force which is larger than a latching force, and for the purpose of release can be again taken out. The latching device 6a may be formed by means of latching webs 3d on the carrier rail 3, projecting from the side walls 3b and in particular running longitudinally continuously, which latching webs in the latching position engage behind latching edges 5d on the side walls 5b which develop preferably continuously in the longitudinal direction, whereby they are elastically bendable to the side by means of the exercise of a certain manual pressing or pulling force and thus can be overcome. The introduction of the light body 5 into the latching device 6a can be simplified by means of oblique surfaces or roundings on the side walls 5b and/or on the latching webs 3d. With the configuration according to FIG. 2, with which the light body 5 is U-shaped, the latching webs 3d may also be elastically yielding upon pressing in and thus may be overcome.

The plug-in connection part 13b is preferably a component associated with the light body 5, which is mounted onto this, so that the light body 5 with the plug-in connection part 13b is moveable against the carrier rail 3 and into the recess 21, whereby the plug-in connection part 13b contacts with the plug-in connection part 13a and the quick-fastening connection 6 comes to function and releasably secures the light body 5 to the carrier rail 3. The plug-in connection part 13b is arranged on the light body 5 preferably off-centre in its longitudinal direction, in particular in its end region.

Since with a lighting strip 1 of a lighting strip system a plurality of lights or light bodies 5 are present it is advantageous for the purpose of avoiding an overloading to provide a plurality of phase conductors of the through-wiring element, e.g. three phase conductors, in this case the wires L1, L2, L3, to which the lights are to be connected in distributed number. Further, the through-wiring has an earthing conductor LE, a neutral conductor LN and two separate emergency current supplies of which the conductors of the first emergency current supply are designated with N1.1 and N1.2 and the conductors of the second emergency supply are designated with N2.1 and N2.2. As can be seen in particular from FIGS. 4 to 6, the contact elements 15 and the associated counter-contact elements 16 are located in two rows R1, R2, preferably extending at right angles to the wires 12, whereby the contact positions for the wires L1, L2, L3, N1.1 and N2.2 are arranged in row R1 and the contact positions for the wires LE, LN, N1.2 and N2.2 are arranged in the other row R2. In order on the one hand to be able to connect the lights A1, A2, A3, . . . to different phases and/or different emergency current supplies there is associated with the plug-in connection part 13a (not shown) or the plug-on connection part 13b in both rows R1, R2, a contact position selecting device 25 which in the case of the present configuration is formed by means of a displacement guide 26a, 26b of which the displacement guide 26a extends over all contact positions of the row R1 and the displacement guide 26b extends with the exception of the contact position for the conductor LE over all other contact positions of the conductors LN to N2.2. In the displacement guide 26a and in the displacement guide 26b in each case at least one carrier for the contact element 16, here a plug shaft 17, is formed as a slider 27 which is manually displaceable in the associated displacement guide 26a, 26b on the body of the plug-in connection part 13b. The lights can thus be connected with three contact elements 16, namely a plug shaft 17 fixedly (earth) and two sliders 27 moveably, selectively to the normal current supply (phase) or emergency current supply.

The displacement guide 26a, 26b is in each case formed by a guide groove 28, in particular an undercut guide groove, extending transversely to the lighting strip 1, in which guide groove the at least one plug shaft 17 is displaceably guided, the slider 27 of which is adapted to the cross-sectional form of the guide groove 28. For arresting in the desired displacement position, namely in the contact position with the desired electrical conductor, there is provided in each case a clamping or latching device 29, which can be overcome, having a latching recess 29a and a latching nose 29b which engages into this, which with the present exemplary embodiment is arranged on the slider 27, or vice versa.

With the present exemplary embodiment the counter-contact element 16 for the earth conductor LE is thus unalterable. All other contact positions are selectable in the respective row R1, R2, for which purpose at least three carriers for the counter-contact elements 16 are needed, in order—in a per se known manner—to select one of the phases L1, L2, L3 and thus to connect the lights A1, A2, A3, . . . to different phases and therewith to use the current supply of the phases as evenly as possible; see the displacement track illustrated in FIGS. 4 and 6 with double arrows.

Further, it is possible selectively to connect lights to the first and/or second emergency current supply. For this purpose there are needed two further counter-contact elements 16, which are to positioned either at the contact positions for the conductors N1.1 and N1.2 or for the conductors N2.1. and N2.2. In order to make this possible, the carriers of the counter-contact elements 16, here the sliders 27, are exchangeable: that is, there are more than three sliders 27 present, so that for one emergency current supply two further sliders 27 can be mounted, which is effected by means of an introduction into the displacement guide 26a, 26b. Carriers or sliders 27 which are not needed can be taken out of the displacement guide and thus removed.

In FIG. 4, the associated light is connected to the mains current supply and to the emergency current supply by means of five contact elements 16, whereby three phases and two emergency current supplies are selectable.

Within the scope of the invention, there can be provided, instead of the at least one emergency current supply or additionally, control current lines which can be connected with associated contact elements 16 in a manner corresponding to that for the emergency current supply, whereby the number of contact positions or lines 123 is to be correspondingly increased.

The above-described configuration of the lighting strip 1 improves on protection standard IP 65 so that the lighting strip 1 is dust-proof and protected against spray water. This protective standard is improved upon by means of the above-described configuration of the carrier rail 3, having—apart from the plug recess 21 for the plug connection part 13b through the cover wall 3c—a continuously closed carrier rail 3 and also by means of the longitudinally continuous latching elements, namely the latching webs 3d, which bear throughout on the side walls 5b. In the abutment region of the carrier rail 3 and of the light body 5, the protective standard is ensured by means of seals 24.

The mounting of the lighting strip sections 2 can be effected at the place of manufacture or at the site of installation. The carrier rails 3, the light body 5 and the through-wiring 12 with the plug-in connection parts 13a are in each case pre-fabricated to this extent and made available, for example on a roll. The through-wiring 11 can thereby in each case be adapted to the length L of the light strip section 2, if applicable with an excess in the joint region as necessary for the electrical connection, or may form a long supply reserve. Significant is that the spacings of the plug-in connection parts 13a with slides 19 pre-fabricated on the through-wiring 11 correspond to the spacings of the recesses 21 from one another which correspond to the lengths L, but are axially offset with regard to the joints 1a.

The mounting of the through-wiring 11 with the at least one plug-in connection part 13b is effected in that it is introduced longitudinally into the carrier rail 3, which may be effected by means of pushing and/or pulling. Thereby, the longitudinal wiring 11 is introduced so far that the plug-in connection parts 13a or slides 19 are located in the longitudinal position of the recesses 21. This position can be defined by means of a movement stop (not illustrated), which for example projects through the associated recess 21 into the path of movement of the slide 19. This fixing can be effected by means of stops placed into the recesses or for example frames which function as stops and which co-operate with counter-stops on the apposing plug-in connection part or slides. Thereby the thus formed arresting parts may also engage into holes in the plug-in connection parts or slides. Further, such an arresting can be effected by means of screws (not shown) penetrating through the cover wall 3c of the carrier rail 3 and engaging into the plug-in connection parts 13a or slides 19. In the transverse direction, the plug-in connection part 13a is positioned in the carrier rail 3 by means of their walls, which form a transverse positioning device 31. After the introduction, the longitudinal positioning can be effected by means of the available plug-in connection part or parts 13b, which by means of the form-fitting engagement into the associated plug-in connection part 13a form a longitudinal positioning device 32.

A dismounting of the through-wiring 11 with the plug-in connection part or parts 13a is effected in a reverse manner by means of longitudinally directed pulling out from the carrier rail 3.

With all above-described exemplary embodiments it is advantageous, for the purpose of additional improvement of the covering or sealing of the hollow space of the carrier rail 3, to cover over or to seal with a closure part the recesses 21 which are not occupied with a plug-in connection part 13b, 13b1, 13b2. For this purpose there can serve in each case a closure plate 35 for example in the configuration and arrangement in accordance with FIG. 14, which covers or seals the associated recess 21. With the exemplary embodiment according to FIG. 14, the closure plate 35 is releaseably connected to the cover wall 3c, preferably by means of a latching device 36. The closure plate 35 may have an insertion part 37 on one broad side which is insertable into the recess 21 and which for example clamps therein or preferably is latchable therein with the latching device 26. Thereby, the closure plate 37 may have a flange 38 which engages over the outer—with reference to the hollow space—recess edge of the recess 21 and thereby not only secures the position of the closure plate 35 but can also act in a covering and sealing manner. The latching device 36 may have a plurality of latching noses arranged distributed around the periphery, or a continuous latching edge 39, which in each case engage behind the inner edge of the recess 21. This engagement behind need only be slight. Due to the material elasticity present at least in the region of the latching edge 39, the closure plate 35 can be pressed and latched into the recess 21 by means of rounded or chamfered introduction surfaces 41, and can drawn out of the recess 21 by means of a pressing out, for example with the aid of a screw driver engaging beneath the flange 38, with a slight application of force. The closure plate 35 is preferably of plastics having an elasticity as described above.

It is further advantageous to provide recesses 21 for all possible different positions of the plug-in connection parts 13b or 13b1, 13b2, so that in this respect the carrier rail 3 is suitable for all positions.

1. Electrical connection device for contacting conductor wires of a strip-type conductor element extending in a given direction in said connection device with conductor wires of an electrical consuming unit which extend in a direction transverse to said given direction, said connection comprising:
a coupling part and a counter-coupling part configured to be plugged together, each of said parts having plural contact elements which, upon plugging together of said parts, make current connections between selected ones of said conductor wires of said strip-type conductor element with said conductor wires of said electrical consuming unit, the contact elements of each of said coupling and said counter-coupling parts being arranged in first and second rows, each of which rows extending in said direction transverse to said given direction;
a first contact position selection device associated with said first row and configured to permit displacement of at least one contact element associated with said first row between at least two contact positions along said first row; and
a second contact position selection device mounted to be displaced along said second row for moving at least one of the contact elements arranged in said second row between at least two contact positions along said second row.

2. Electrical connection device according to claim 1, wherein:
a ground contact is mounted non-displaceably in one row of said first and second rows.

3. Electrical connection device according to claim 2, wherein:
a displacement path of said first contact position selection device along said one row includes said ground contact and extends over all other contact positions present in said one row.

4. Electrical connection device according to claim 1, wherein:
a displacement path of said second contact position selection device along said other row does not contain said ground contact and extends over all contact positions.

5. Electrical connection device according to claim 1, wherein:
at least of said selection devices comprises a displacement guide and a slide, said slide carrying an associated contact element and being displaceable in said displacement guide for positioning at each of said contact positions.

6. Electrical connection device according to claim 5, wherein:
said slide includes a latching device for latching said slide at said contact positions.

7. Electrical connection device according to claim 6, wherein:
said latching device is configured to become unlatched by the application of manual force thereto.

8. Electrical connection device according to claim 1, wherein:
said device includes at least five contact positions.

9. Electrical connection device according to claim 1, wherein:
said device includes nine contact positions.

10. Electrical connection device according to claim 1, wherein:
said device includes contact elements movable to contact positions for connection to one or two emergency current supplies and at least one control current supply.

11. Electrical connection device according to claim 1, wherein:
said device is provided with at least one control current supply.

12. Electrical connection device according to claim 1, wherein:
said device is provided with at least one emergency current supply and at least one control current supply.
